(19) United States
(12) Patent Application Publication
(10) Pub. No.: US 2016/0028961 A1
(43) Pub. Date: Jan. 28, 2016

(54) Visual Media Capture Device For Visual Thinking

(71) Applicant: Indran Rehan Thurairatnam, Henderson, NV (US)

(72) Inventor: Indran Rehan Thurairatnam, Henderson, NV (US)

(21) Appl. No.: 14/807,866

(22) Filed: Jul. 23, 2015

Related U.S. Application Data
(60) Provisional application No. 62/028,267, filed on Jul. 23, 2014.

(51) Int. Cl. H04N 5/232; G06F 3/0481; G06F 3/01

(52) U.S. Cl. CPC H04N 5/23293; H04N 5/23216; G06F 3/016; G06F 3/04817

(57) ABSTRACT

An electronic device (100) includes digital image sensors (106) to capture visual media (114), a display (102) to present a visual representation of existing organizational categories and the option to create a new category, and a touch controller (103) to identify haptic contact engagement, haptic contact location and haptic contact release on the display. A visual media capture controller (110) organizes visual media (114) captured by the digital image sensors (106) into new and existing categories by presentation of a visual representation of organizational categories and the option to create a new category upon the display as a two-dimensional representation of a three-dimensional carousel, identifying a predetermined number of haptic signals of predetermined type (a “predetermined haptic signal pattern”), generating organizational information based upon information generated by the touch controller (103) regarding the predetermined haptic signal pattern, and recording the organizational information. Advantages of one or more aspects of the invention include that they facilitate visual thinking. Other advantages of particular embodiments will be apparent from a consideration of the drawings and ensuing description.

### CROSS-REFERENCED APPLICATIONS

This application claims the benefit of U.S. Provisional Application No. 62/028,267, filed Jul. 23, 2014, which is incorporated by reference.

This application references the organizational visual media capture device disclosed in U.S. Non-Provisional patent application Ser. No. 14/715,596, filed May 19, 2015, which is incorporated by reference.

### BRIEF DESCRIPTION OF THE FIGURES

The invention is more fully appreciated in connection with the following detailed description taken in conjunction with the accompanying drawings, in which:

FIG. 1 illustrates components of an electronic device implementing an embodiment of the invention.

FIG. 2 illustrates processing operations associated with an embodiment of the invention.

FIG. 3 illustrates the exterior of an electronic device implementing an embodiment of the invention.

FIG. 4 illustrates the exterior of an electronic device implementing an embodiment of the invention.

FIG. 5 illustrates processing operations associated with an embodiment of the invention.

FIG. 6 illustrates the exterior of an electronic device implementing an embodiment of the invention.

FIG. 7 illustrates processing operations associated with an embodiment of the invention.

FIG. 8 illustrates the exterior of an electronic device implementing an embodiment of the invention.

Like reference numerals refer to corresponding parts throughout the drawings.

### BACKGROUND

Existing visual media capture devices implement a single physical or virtual button for initiating capture upon a press of the button and terminating capture automatically, upon release of the button, or upon another press of the button. Automated data collection at the time of capture allows for a crude organization of captured media based upon objective characteristics such as time or location of capture. The organization of large quantities of captured visual media is a longstanding problem. This problem has worsened with the increasing ease of use and availability of visual media capture devices, such as smartphones, with large amounts of data storage capacity. I have found it a major shortcoming that existing designs do not provide any adequate mechanism for creative or subjective categorization responsive to the captured media. Creative or subjective categorization differs qualitatively from uses of visual media capture served by current designs; designs that provide for such are of great utility to visual thinkers including creatives working in visual industries. The organizational visual media capture device I disclosed in U.S. Non-Provisional patent application Ser. No. 14/715,596, filed May 19, 2015, includes my initial developments that address the shortcomings in existing designs that I have found by facilitating visual thinking.

### SUMMARY

An electronic device includes digital image sensors to capture visual media, a display to present a visual representation of existing organizational categories and the option to create a new category, and a touch controller to identify haptic contact engagement, haptic contact location and haptic contact release on the display. A visual media capture controller organizes visual media captured by the digital image sensors into new and existing categories by presentation of a visual representation of organizational categories and the option to create a new category upon the display as a two-dimensional representation of a three-dimensional carousel, identifying a predetermined number of haptic signals of predetermined type (a “predetermined haptic signal pattern”), generating organizational information based upon information generated by the touch controller regarding the predetermined haptic signal pattern, and recording the organizational information. Advantages of one or more aspects of the invention include that they facilitate visual thinking. Other advantages of particular embodiments will be apparent from a consideration of the drawings and ensuing description.

### DETAILED DESCRIPTION

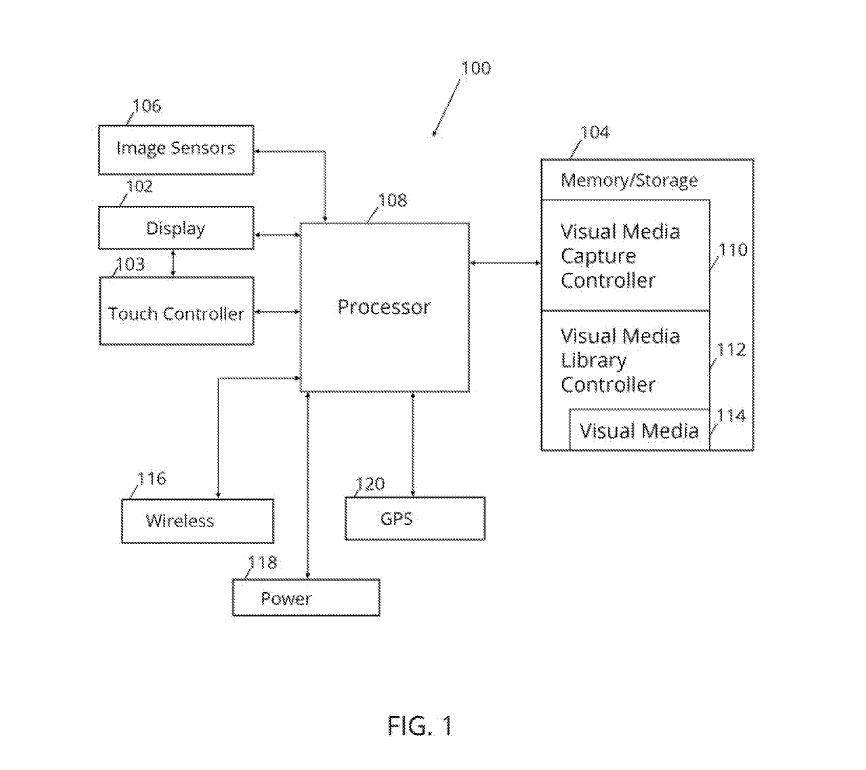

FIG. 1 illustrates a visual media capture device 100, implementing operations of the invention. The visual media capture device 100 may be a digital camera, smartphone or any other digital device with visual media (for example, photographs and/or video) capturing function. In one embodiment the media capture device 100 is a smartphone, which includes a number of functional units such as: a display unit 102, a touch controller 103, a memory/storage unit 104, an image sensor unit 106, a processing unit 108, a visual media capture controller 110, and visual media library controller(s) 112.

The touch controller 103 is responsive to haptic signals applied to the display unit 102 and is also connected to the processing unit 108. The processing unit 108 may be a central processing unit and/or a graphics processing unit, which is/are in communication with the memory/storage unit 104. The memory/storage unit 104 is a combination of flash memory and random access memory. The memory/storage unit 104 stores a visual media capture controller 110 and one or more visual media library controller(s) 112 to implement operations of the invention. The visual media capture controller 110 interacts with the visual media library controller(s) 112, which include(s) executable instructions to store, organize and present visual media 114. The visual media capture controller 110 includes executable instructions for capturing the visual media and for receiving organizational information from the user based upon the processing of haptic signals, as discussed below.

In one embodiment, one of the visual media library controller(s) 112 is a media library controller capable of storing, organizing and presenting visual media without receiving any language-based descriptive information, such as titling information, from the user. The remainder of the visual media library controller(s) 112 may be standard media library controllers known in the art, which require text-based titles for the organizational categories (colloquially “albums”). In another embodiment, for backwards compatibility similar functionality can be achieved using only standard visual media library controller(s) 112, where the visual media capture controller 110 generates titling information to pass to the visual library media controller(s) 112 automatically, without user interaction. The executable instructions contained in the visual capture controller 110 are designed such that the titling information generated thereby meets the validity requirements of the visual library media controller(s) 112 without requiring user input to generate the titling information. In both of said embodiments, the design of the visual media capture controller 110 enables organizing captured media using a predetermined number of contact signals of predetermined type (a “predetermined haptic signal pattern”). While both embodiments share the other advantages described herein, the embodiment automatically generating titling information has the additional advantage of backwards compatibility with legacy systems that require titling information for the organizational categories.

In one embodiment, the predetermined haptic signal pattern identified by the visual media capture controller 110 is the haptic contact and subsequent release signals within a short period of time generated by a single tap (or other predetermined haptic signal patterns used to identify a single tap known in the art) on the display 102. The visual capture controller 110 generates and stores organizational information by analyzing the location of the tap on the display 102 and cross-referencing that location with the state of a visual representation upon the display 102 generated by the visual capture controller 110 of both the organizational structure and the option to create a new organizational category. Using solely a visual media capture controller 110 and visual media library controller(s) 112 known in the art precludes using a predetermined haptic signal pattern to create a new category since input of custom, user-provided language based descriptive information such as titling information for creation of a new category can not be achieved solely via a predetermined haptic signal pattern. Using a touch screen keyboard to input natural language titling information, for example, requires a variable number of haptic contact signals since the number of characters in a title desired by the user can not be known in advance and thus can not be achieved using a predetermined number of haptic signals. Other embodiments include where the predetermined haptic signal pattern is generated by the user by tapping twice, swiping, pinching, etc. upon the display 102. Using exclusively predetermined haptic signal patterns facilitates more rapid and precise collection of organizational information on-the-fly as disclosed in patent application U.S. Pat. No. 8,428,453, which enhances uses of the device for creativity and visual thinking as well as certain more traditional uses of the device.

The visual media capture device 100 may also include other components commonly associated with a smartphone or digital camera or other visual media capture device, such as a wireless communications unit 116, a power control unit 118 and a global positioning system unit 120. While many of the components of FIG. 1 are known in the art, new functionality is achieved through the visual media capture controller 110 and the visual media library controller(s) 112.

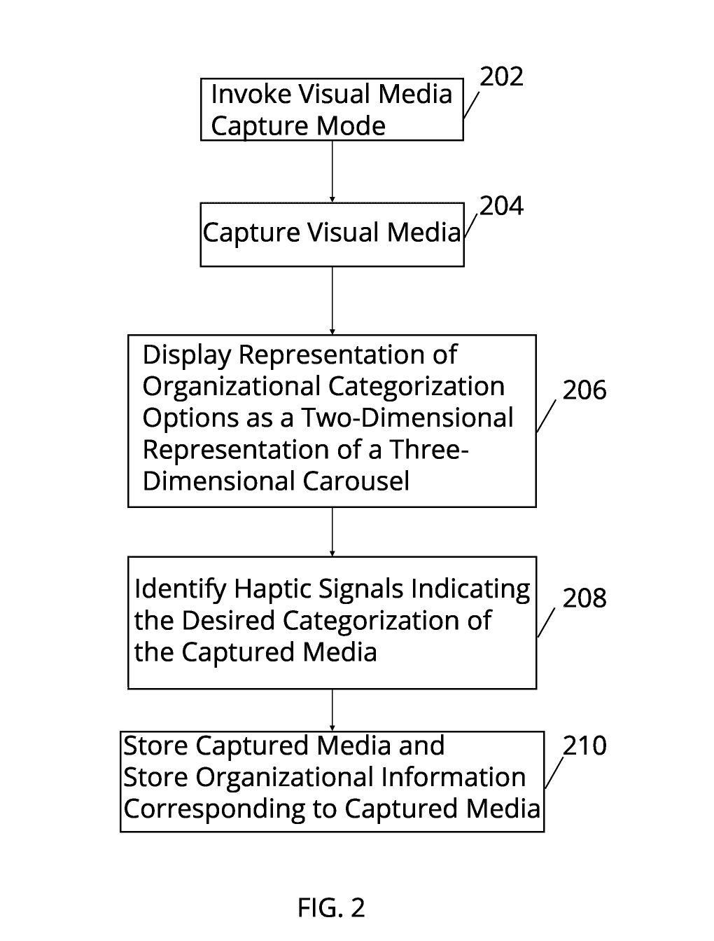

FIG. 2 illustrates processing operations associated with particular embodiments of the visual media capture controller 110. Initially, a visual media capture mode is invoked 200. For example, various smartphone interfaces allow a user to access a camera application presented on the display 102 by tapping an icon representing that application. Doing so invokes a visual media capture mode, activating the visual media capture controller 110.

A visual media capture mode can be invoked in many other ways known in the art. For example, the device may be dedicated to visual media capture, such as with digital camera devices and may enter a visual capture mode automatically upon the device being turned on. One additional example is when an application running on a smartphone device invokes a visual capture mode as part of a larger operation, such as during construction of a social media post.

The visual media capture controller 110 includes executable instructions executed by the processing unit 108 to simultaneously present the user with a live preview of the captured media and a capture interface upon the display unit 102. The image sensor unit 106 transmits to the processing unit 108 information regarding a capture operation, including a live preview of the capture operation and media resulting from the capture operation.

The touch controller 103 detects haptic signals upon the display 102, which cause the visual media capture controller 110 to capture visual media 202. These haptic signals are interpreted by executable instructions included in the touch controller 103 and executed by the processing unit 108. These haptic signals determine certain parameters of the media capture including when it begins and ends.

The aforementioned capture interface created by the visual media capture controller 110 and executable instructions contained in the touch controller 103 interpreting the haptic signals thereupon can be any of the variations known in the art. In one embodiment, the user taps a visual representation of a camera shutter button upon the display unit 102, generating haptic signals interpreted by the touch controller 103 to indicate the instant that the image sensor unit 106 should capture a photograph. In another embodiment, the user may tap and hold a visual representation of a button to capture a photograph or video alternatively in accordance with the device disclosed in U.S. Pat. No. 8,428,453 granted Apr. 23, 2013.

At some point after the visual media capture, the media captured by the image sensor unit 106 is passed to the visual media library controller(s) 112 and stored thereby 208. In one embodiment, the visual media capture controller 110 includes executable instructions to enter a visual media preview mode immediately after a visual media capture (not illustrated in FIG. 2). Consequently, a user can conveniently review recently captured media and/or perform various other actions with the captured media such as editing it, sharing it and various other actions as known presently in the art.

Also after the visual media capture, the visual media capture controller 110 displays a representation of the existing organizational structure and representation of the option to create a new organizational category 204. After the visual media capture, the visual media capture controller 110 transmits executable instructions to the processing unit 108 to retrieve from the one or more visual media library controller(s) 112 the information required to present the existing categories of visual media. The visual media capture controller 110 includes executable instructions executed by the processing unit 108 to display upon the display unit 102 a visual representation of the existing organizational structure in the visual media library controller(s) 112 as well as a visual representation of the option to create a new organizational category within the visual media library controller(s) 112.

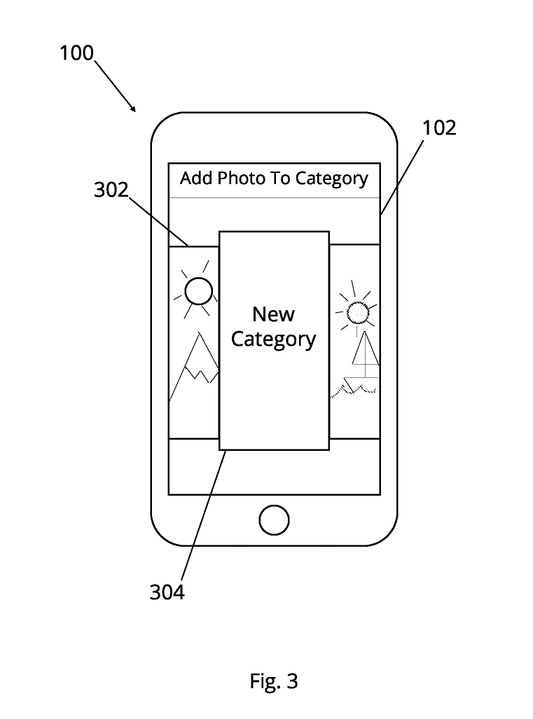

The visual representation of the organizational structure and the option to create a new organizational category is a two-dimensional representation of a three-dimensional carousel (where a “carousel” is a cylindrical arrangement of panels which move together around a rotational axis and thus wrap around back to the initial panel) with simulated axis of rotation parallel to the longer sides of the device 302 as illustrated in FIG. 3. Thusly, the frontmost panel of the carousel receives more prominent size and placement than the other panels naturally as a consequence of the simulated three-dimensional perspective in order to attract visual focus to a single panel at a time 304 as shown in FIG. 3. In the carousel, each panel represents either the option to create a new organizational category or an organizational category. Each panel representing a category contains a visual representation of the category such as one or more photographs already contained within the category. This embodiment enhances the ability of the user to rapidly visually scan the existing organizational structure, which expedites selecting an organizational category for the captured media. Additionally, for handheld form factor devices such as certain smartphones, this embodiment enhances the ability of the user to operate the device with only one hand by favoring a natural lateral thumb motion to scroll through the organizational categories. This is a significant advantage over devices displaying organizational categories known in the art prior to the disclosures of my patent application U.S. Pat. No. 8,428,453, which typically use a flat vertically-scrolling table layout with long text descriptions accompanying small thumbnails representing organizational categories. The vertically-scrolling table layout known in the art favors using a vertical thumb motion to scroll, which is uncomfortable to use during one handed operation of the device.

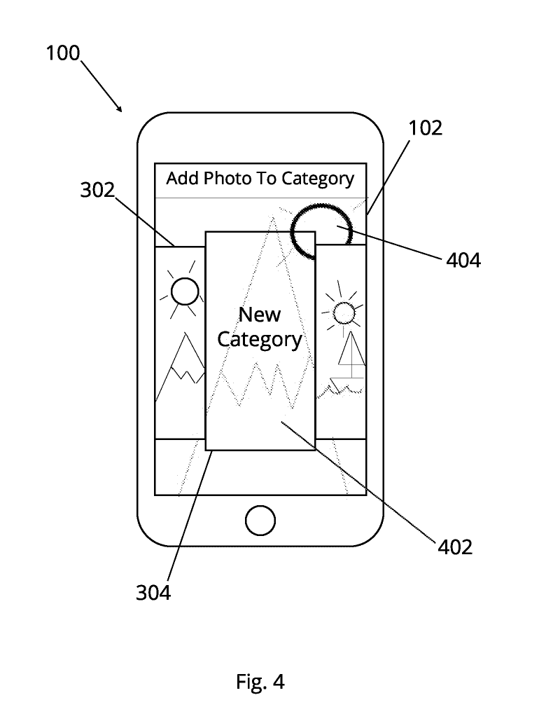

In one embodiment, illustrated in FIG. 4, one or more panels of the carousel incorporate some transparency effects (such that they the panel(s) doing so are either transparent or translucent) 402 and the background upon which the carousel is displayed is a preview image of the captured image 404 allowing the user to preview the image simultaneously with the display of the organizational structure. This combines the traditional step of previewing a photo after capture with the step for organizing the photo, which further enhances the convenience of this technology and facilitates visual thinking.

The user may touch the display 102 attempting to cause the visual representation of the carousel to rotate, or otherwise move, in order to change the panel in the carousel receiving visual focus. Upon the user doing so, the touch controller 103 transmits information regarding said haptic signals to the visual media capture controller 110, which interprets the haptic signals and transmits executable instructions to the processing unit 108. In response to said instructions, the processing unit 108 updates the visual representation upon the display 102 in accordance with the received executable instructions and the visual media capture controller 110 keeps track of the current state of the visual representation.

Subsequent to the display unit 102 displaying the visual representation of the organizational structure, the visual media capture controller 110 identifies a predetermined haptic signal pattern indicating the desired categorization of the captured media 206. The touch controller 103 transmits haptic signals to the visual media capture controller 110, which recognizes the predetermined haptic signal pattern and transmits executable instructions to the processing unit 108 that cause the visual media library controller(s) 112 to store the organizational category to which the captured visual media should be assigned, new or pre-existing 208. The visual media library controller(s) 112 include(s) executable instructions executed by the processing unit 108 to store the organizational information in the memory/storage unit 104.

The foregoing embodiment relies upon evaluating haptic signals. Captured media is organized based upon recognizing a predetermined haptic signal pattern. A single tap on the visual representation of the desired organizational category or a visual representation of the desire to create a new category is sufficient to organize the captured visual media. Thus, visual media may be organized, including creation of new categories, at the time of capture with less effort than methods known in the art. This also allows for more precise organization based upon fleeting thoughts, ideas and emotions that exist at the time of capture and enhances the ability to use the device for visual thinking, which are creative uses of visual media capture devices for which the devices previously known in the art have not been optimized.

In another embodiment the organizational visual media capture device may conduct a visual media capture as a subcomponent of a larger process, such as, for example, creating a social media post. In such a case, the displayed representation of organizational structure and a representation of the option to create a new organizational structure may be passively bypassed without any user interaction with the organizational options by recognizing a predetermined haptic signal pattern indicating that the larger process should proceed and/or terminate such as, for example, a single tap on a button to finalize the social media post. This is functionally equivalent to selecting an option to organize the visual media into a default/catch-all category. This embodiment has all of the advantages of the previously described embodiments over the prior art. An additional advantage of this embodiment utilizing a visual media capture as a subcomponent of a larger process is that it offers the user a more complete experience for performing specific tasks, saving the user time and effort.

In alternate embodiments some or all of the memory/storage may not be a part of the memory/storage unit 104 and may be connected via a wireless data connection such as Wi-Fi, cellular data, Bluetooth, etc. For example, where the organizational visual media capture is for the purpose of creating a social media post, the captured media may be stored at a remote location controlled by the social media company. Various combinations of storage contained within the device and storage not contained within the device are possible, each with all of the advantages of the previously described embodiments over the prior art.

Similarly, in alternate embodiments some or all of the processing may not be performed by the processing unit 108 and may be connected via a wireless data connection such as Wi-Fi, cellular data, Bluetooth, etc. Colloquially, arrangements where some or all of the processing or memory/storage are not a part of the device are called “cloud” arrangements, each of which maintains all of the advantages of the previously described embodiments over the prior art. Advantages of a cloud arrangement include the ability to offer a more portable device than a comparable device not utilizing a cloud arrangement and other advantages known in the art.

In an alternate embodiment, immediately after a visual capture the visual media capture controller 110 displays the visual representation of the organizational structure and the option to create a new organizational category. Such an embodiment does not present the user with a preview of the captured media immediately after capture (as illustrated in FIG. 2). An alternate embodiment displays a visual representation of the organizational structure and the option to create a new category simultaneously with a preview of the capture media. Said embodiments have all of the advantages of the previously described embodiments over the prior art, with the additional advantage of enabling faster visual media captures.

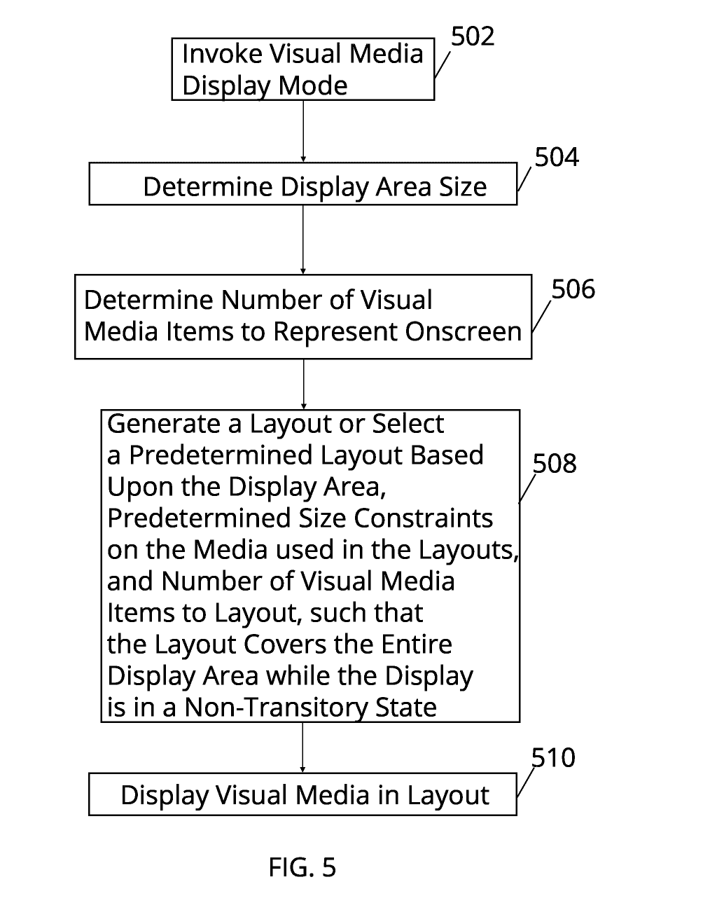

FIG. 5 illustrates processing operations associated with particular embodiments of the visual media library controller(s) 112. Initially a visual media display mode is invoked 502. For example, a user may access an application presented on display 102 to invoke a visual media display mode, activating a visual media library controller 112.

The visual media library controller 112 includes executable instructions executed by the processing unit 108 to either access the memory/storage unit 104 to determine the size of the area of the display unit 106 in which to display the visual media or to access the display unit 106 to determine its dimensions 504.

The visual media library controller 112 includes executable instructions executed by the processing unit 108 to access the memory/storage unit 104 to determine the number of visual media 114 items to be represented onscreen 506.

The visual media library controller 112 further includes executable instructions executed by the processing unit 108 to generate a layout for the displayed visual media 114 based upon the number of visual media items to layout, one or more predetermined size constraints on the media used in the layouts, and the size of the area of the display unit 106 upon which to display said visual media 508. Alternately, where the size of the display area is known in advance, the visual media library controller may include executable instructions executed by the processing unit 108 to choose from a predetermined set of layouts for the visual media 114 based upon the number of visual media 114 items to layout and one or more predetermined size constraints on the media used in the layouts 506.

In both cases, such layout is created or chosen such that the total display area of the visual media 114 items, including borders such as spacing margins between and around such items, covers the entire subset of the area of the display upon which the media 114 is to be displayed at all times when the display is not in a transitory state and any portion of such layout 114 is to be displayed on screen. This maximizes the size of the displayed images in any given area used to display visual media for a given number of maximum visual media items to be displayed on screen, which is of particularly high value for devices with small displays, including portable devices such as smartphones and tablets.

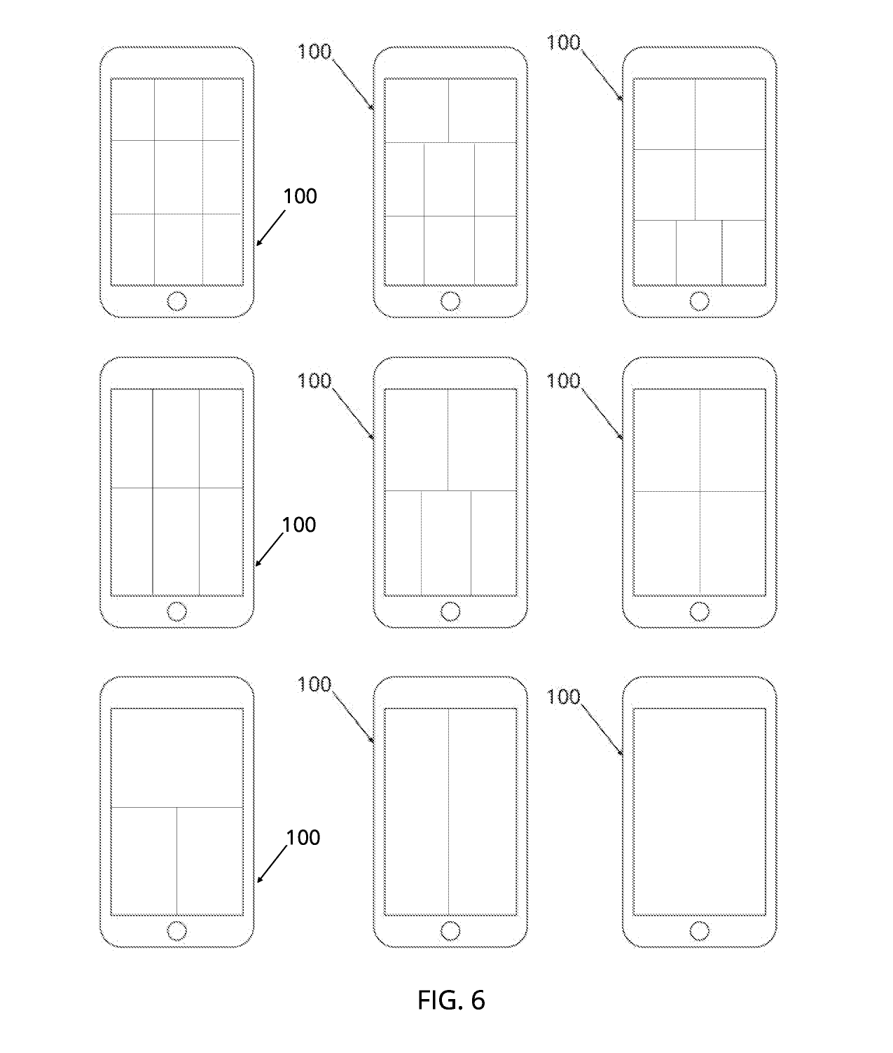

In one embodiment, illustrated in FIG. 6, the layouts visible when the display is not in a transitory state are one of the following layouts, covering the entire screen, where the representative images are of equal height and within each subarray indicated are of equal width: a three by three array of nine total, an array with dimensions of one vertical image and two horizontal images atop an array with dimensions of two vertical images and three horizontal images of eight total, an array with dimensions of two vertical images and two horizontal images atop an array with dimensions of one vertical images and three horizontal images of seven total, an array with dimensions of two vertical images and three horizontal images of six total, an array with dimensions of one vertical image and two horizontal images atop an array with dimensions of one vertical image and three horizontal images of five total, a two by two array of four total, a one by one array atop an array of dimensions of one vertical image and two horizontal images of three total, a one by two array of two total, or a one by one array of one total. This embodiment is exemplary and the particular layouts may be adapted for different display sizes, different display proportions, and the desired aesthetic qualities.

The visual media library controller 112 further includes instructions to display the visual media 114 items in accordance with the generated or chosen predetermined layout 508.

In one embodiment, the visual media library controller 112 additionally selects between various representations (e.g., thumbnail, preview, fullscreen, full-size) of the visual media 114 to display in the layout based upon the location and size of the visual media in said layout.

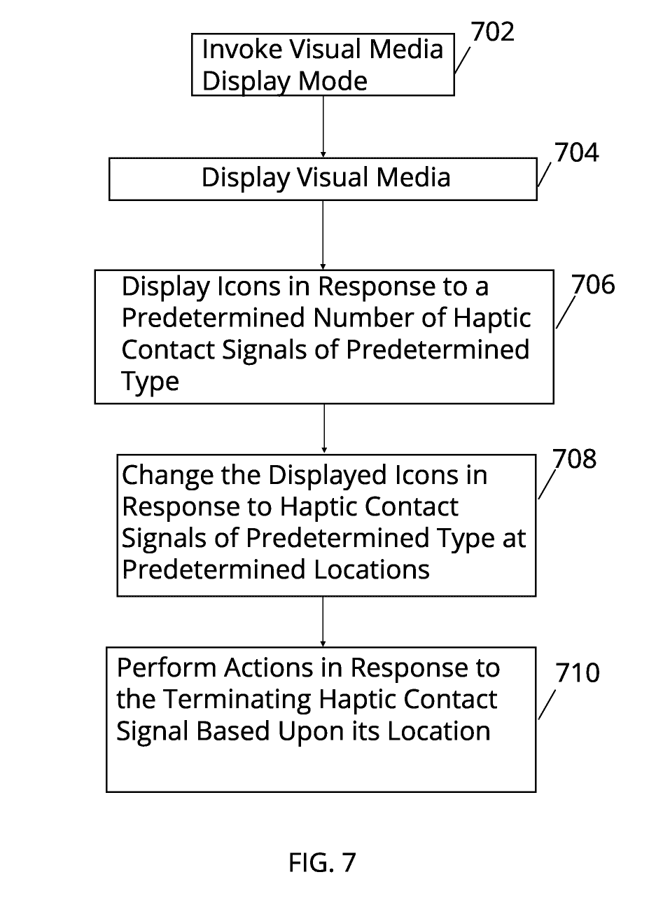

FIG. 7 illustrates processing operations associated with an embodiment of the visual media library controller(s) 112, which facilitates a particular type of drag and drop operation, which in addition to other uses, is well suited to enhancing the visual thinking experience by enabling less screen area to be devoted to buttons for manipulating the displayed visual media. Initially a visual media display mode is invoked 702. For example, a user may access an application presented on display 102 to invoke a visual media display mode, activating a visual media library controller 112.

The visual media library controller 112 includes executable instructions executed by the processing unit 108 to display representations of the visual media 114 items to be represented onscreen 704 as known in the art including as disclosed in FIG. 5 and FIG. 6 and as described in the foregoing description of those figures.

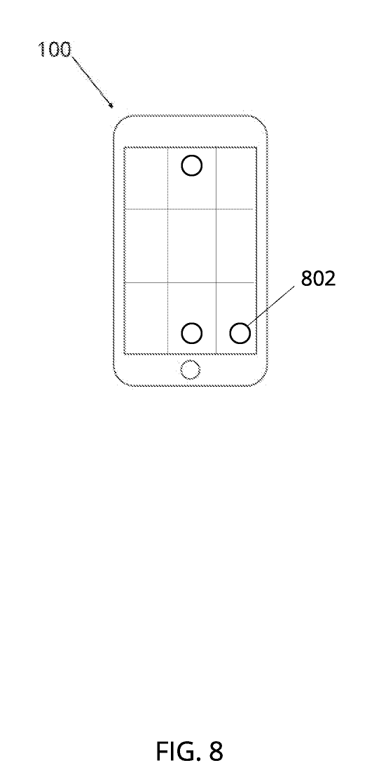

The touch controller 103 detects haptic signals 706 upon the display 102, which cause the visual media library controller 112 to display icons 802, illustrated in FIG. 8, representing actions that can be performed on the visual media 114. In one embodiment, the touch controller 103 detects signals corresponding to a “long touch” gesture whereby the user touches an image and continues touching it for a predetermined length of time, which causes the visual media library controller 112 to cause the display 102 to show icons corresponding to sharing the represented visual media, deleting it, or changing its organizational categorization. In another embodiment the visual media library controller 112 does the same in response to the touch controller detecting signals corresponding to a “pinch” gesture whereby the user places two fingers on the display and moves them closer together while maintaining contact with the display. In some embodiments the icons so displayed are of neutral coloration, such as black and white, gray and off-white, navy blue and off-white, or other neutral colorations of limited palette, which indicate an inactive state.

The touch controller 103 continues detecting haptic signals upon the display 102, whereby the visual media library controller 112 either stops displaying said icons, continues displaying said icons without change, or changes the displayed icons 708. In one embodiment the detected haptic signals correspond to “dragging” gestures on the screen whereby haptic contact persists while the location of haptic contact changes, such that the visual media library controller 112 determines whether any icon should be activated and which icon should be activated based upon the location of haptic contact at that instant. The changed icon is visual feedback to the user representing which icon is active and thus which action will occur in response to terminating haptic contact with the display 102. In one embodiment, the changed icon merely changes the colors of the prior icon. In some embodiments the changed colors are not neutral combinations, but bright colors, such as bright green and white, bright red and white, bright blue and white, thus indicating an active state. In some embodiments the locations of haptic contact causing the icons to change do not correspond to the size and shape of the displayed icons in order to facilitate using icons smaller than finger sizes.

In response to the haptic contact signal signaling termination of haptic contact at predetermined locations, which need not correspond to the icon size and shape, the visual media library controller 112 performs corresponding executable instructions 710. This facilitates a drag and drop interface for photo organization and management on a touch screen by alleviating the problem of limited screen real estate since the icons are only shown upon recognition of specific haptic signals. It also alleviates the problem of the lower precision of touch controls relative to mouse controls on desktop computers, by allowing more screen area to be devoted to touch controls. This precision problem makes it difficult to create an effective drag and drop interface for mobile touch screen devices such as smartphones, which have very limited screen area. This is also particularly useful for use in conjunction with layouts of visual media using the entire screen such as certain embodiments illustrated in FIG. 6.

An embodiment of the present invention relates to a computer storage product with a computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; SD cards; flash cards; and hardware devices that are specially configured to store and execute program code, such as application-specific integrated circuits (“ASICs”), programmable logic devices (“PLDs”) and ROM and RAM devices.

Examples of computer code include machine code, such as produced by a compiler, and files containing higher-level code that are executed by a computer using an interpreter. For example, an embodiment of the invention may be implemented using JAVA®, C++, Objective C or other programming languages and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

The invention claimed is:

1. An electronic device, comprising:
digital image sensors to capture visual media;
a display to present a visual representation of organizational categorization options;
a touch controller to identify haptic contact engagement, haptic contact position and haptic contact release on the display; and
a visual media capture controller to organize visual media captured by the digital image sensors by presentation of a visual representation of organizational categories and the option to create a new category upon the display as a two-dimensional representation of a three-dimensional carousel, identification of haptic contact signals of predetermined type, generation of organizational information based upon information generated by said touch controller regarding the predetermined number of haptic contact signals of predetermined type, and recordation of said organizational information.

2. The electronic device of claim 1, where said visual media capture controller includes instructions to include one or more panels incorporating transparency effects in said visual representation of organizational categories and the option to create a new category and where the visual representation is presented upon a background of a preview of captured visual media.

3. The electronic device of claim 1, where said visual media capture controller includes to instructions to initially display said visual representation of organizational categories and the option to create a new category in a transient state simulating rotation of the two-dimensional visual representation of a three-dimensional carousel for a predetermined period of time.

4. The electronic device of claim 2, where said visual media capture controller includes instructions to initially display the visual representation in a transient state simulating rotation of the two-dimensional visual representation of a three-dimensional carousel for a predetermined period of time.

5. The electronic device of claim 1, additionally comprising a visual media library controller including instructions to generate layouts for presented visual media based upon the number of media items and one or more predetermined size constraints on the media used in the layouts, where such layouts cover the entire display area with a subset of the visual media and borders while the display is in a non-transitory state.

6. The electronic device of claim 1, additionally comprising a visual media library controller including instructions to select a layout to present visual media from a predetermined set of layouts based upon the number of media items and one or more predetermined size constraints on the media used in the layouts where such layouts cover the entire display area with a subset of the visual media and borders while the display is in a non-transitory state.

7. The electronic device of claim 1, additionally comprising a visual media library controller including instructions to present said visual media, identify haptic contact signals on the display, identify a haptic contact initiation signal, present icons on the display in response to a predetermined number of haptic contact signals of predetermined type, change the displayed icons on the display in response to haptic contact signals of predetermined type at predetermined locations identified prior to a haptic contact termination signal corresponding to said haptic contact initiation signal, and perform actions in response to the haptic contact signal signaling termination of haptic contact when said termination signal is in one of one or more predetermined locations.

8. The electronic device of claim 7, where said visual media library controller includes instructions to present said icons with neutral coloration and to change said displayed icons into icons of non-neutral coloration in response to a predetermined number of haptic contact signals of predetermined type.

9. A non-transient computer readable storage medium, comprising executable instructions to:
record visual media;
display a visual representation of existing organizational categorization options, where said visual representation is in the form of a two-dimensional representation of a three-dimensional carousel;
process haptic contact signals from a display;
generate organizational information for said visual media based upon information resulting from processing haptic contact signals; and
record said organizational information.

10. The non-transient computer readable storage medium of claim 9, where the instructions to display the visual representation of organizational categorization options include instructions to do so with at least one translucent or transparent panel upon a background of a preview of captured visual media.

11. The non-transient computer readable storage medium of claim 9, where the instructions to display a visual representation of existing organizational categorization options include instructions to initially display the two-dimensional visual representation in a transient state simulating rotation of the three-dimensional carousel for a predetermined period of time.

12. The non-transient computer readable storage medium of claim 10, where the instructions to display a visual representation of existing organizational categorization options include instructions to initially display the two-dimensional visual representation in a transient state simulating rotation of the three-dimensional carousel for a predetermined period of time.

13. The non-transient computer readable storage medium of claim 9, additionally including executable instructions to generate layouts for presented visual media based upon a display area upon which the visual media is displayed, one or more predetermined size constraints on the media used in the layouts, and the number of media items, where such layouts cover the entire display area with visual media and uniform borders while the display is in a non-transitory state.

14. The non-transient computer readable storage medium of claim 9, additionally including executable instructions to select a layout to present visual media from a predetermined set of layouts based upon the number of media items and one or more predetermined size constraints on the media used in the layouts, where such layouts cover the entire display area with visual media and uniform borders while the display is in a non-transitory state.

15. The non-transient computer readable storage medium of claim 9, additionally including executable instructions to present visual media, identify haptic contact signals on the display, identify a haptic contact initiation signal, present icons on the display in response to a predetermined number of haptic contact signals of predetermined type, change the displayed icons in response to haptic contact signals of predetermined type at predetermined locations identified prior to a haptic contact termination signal corresponding to said haptic contact initiation signal, and perform actions in response to the haptic contact signal signaling termination of haptic contact when the termination signal originates from one of one or more predetermined locations.

16. The non-transient computer readable storage medium of claim 15, where the executable instructions to present icons on the display includes executable instructions to present the icons with neutral coloration and the executable instructions to change the displayed icons includes executable instructions to change the displayed icons into icons of non-neutral coloration.
